(19) United States
(12) Patent Application Publication
(10) Pub. No.: US 2007/0286361 A1
(43) Pub. Date: Dec. 13, 2007

(54) Sending A Page

(75) Inventors: Julian Wray West, North Hampton, NH (US); Douglas McLetchie, North Hampton, NH (US)

Correspondence Address: FISH & RICHARDSON PC, P.O. BOX 1022, MINNEAPOLIS, MN, 55440-1022, US

(73) Assignee: Whaleback Systems Corporation, Portsmouth, NH (US)

(21) Appl. No.: 11/751,340

(22) Filed: May 21, 2007

Related U.S. Application Data
(60) Provisional application No. 60/808,663, filed on May 26, 2006.

(51) Int. Cl. H04M 11/00

(52) U.S. Cl. 379/88.13

(57) ABSTRACT

Sending a page using session initiation protocol (SIP) includes receiving a call to send the page, determining a paging group that includes one or more devices based on information associated with the call, where the one or more devices are capable of receiving the page, establishing a connection to the one or more devices using SIP invites, and sending the page to the one or more devices.

### CLAIM TO PRIORITY

This patent application claims the benefit of, and priority to, U.S. Provisional Application No. 60/808,663 filed on May 26, 2006 (docket no. 19825-003P01). The contents of U.S. Provisional Application No. 60/808,663 are hereby incorporated by reference into this patent application as is set fourth herein in full.

### TECHNICAL FIELD

This patent application relates generally to sending a page over a network to one or more network devices and, more particularly, to using session initiation protocol (SIP) when sending the page.

### BACKGROUND

Voice over Internet protocol (VoIP) enables users to make telephone calls over a computer network, such as the Internet. VoIP is used to convert a voice signal from a telephone into a digital signal, which can be transmitted over the computer network. At a receiving end, VoIP is used to convert the digital signal back into a voice signal.

SIP is a signaling protocol for VoIP. In particular, SIP is a request/response protocol that allows devices to set up a communication session over a network. Real-time transport protocol (RTP) is typically used during the communication session to carry voice and other data between the devices on the network.

### SUMMARY

This patent application describes methods and apparatus, including computer program products, for sending a page over a network to one or more network devices using SIP.

In general, this patent application describes a method of sending a page using SIP. The method comprises receiving a call to send the page, determining a paging group comprising one or more devices based in information associated with the call, where the one or more devices are capable of receiving the page, establishing a connection to the one or more devices using SIP invites, and sending the page to the one or more devices. The method may also include one or more of the following features, either alone or in combination.

The information associated with the call may comprise an extension in the call. Determining the paging group may comprise retrieving information associated with the one or more devices using the extension. The information associated with the one or more devices may comprise at least one of an extension of a device, an indication of whether the extension is primary for the service, a SIP uniform resource identifier of a device, and an Internet Protocol (IP) address if a device.

The one or more devices to which a page may be sent may comprise a target device. Establishing a connection to the target device may comprise sending a SIP invite to the target device, and waiting a predetermined period of time for a reply to the SIP invite. If the reply is received within the predetermined amount of time, the method may comprises sending an inaudible tone to the target device. If the reply is not received within the predetermined period of time, the method may comprise ceasing attempts to establish a connection to the target device. The method may comprise repeating sending the SIP invite to the target device several times within the predetermined period of time if the target device does not reply within a fraction of the predetermined amount of time or the predetermined amount of time.

Establishing the connection may comprise synchronizing the one or more devices by readying the one ore more devices to receive the page. Synchronizing may be performed by sending SIP invites to the one or more services and receiving responses from the one or more devices. The method may comprise identifying a caller sending the page, and confirming that the caller is authorized to send the page. The page need not be sent if the caller is not authorized to send the page.

The one or more devices to which a page may be sent may comprise a target device. Determining the paging group may comprise obtaining information indicating whether the target device is in use. In a case that the target device is in use, sending the page may comprise causing audio on the target device to be augmented with the page. The page may be played on the target device at a volume that is lower than a volume of the audio. Causing the audio on the target device to be augmented with the page may comprise one of: instructing the target device to play the page at a same time as the audio, and incorporating the audio into the page before sending the page.

The method may comprise obtaining page information relating to receipt or non-receipt of the page at the one or more services, and logging the page information.

The foregoing method of sending a page may be implemented using one or more machine-readable media. The one or more machine-readable media stores instruction that are executable by one or more processing devices to perform the method. The method may be implemented using one or more apparatus and/or systems that include one or more processing devices and memory for storing instructions that are executable by one or more processing devices.

In general, this patent application also describes a system comprising a paging device, a server application in communication with the paging device, and paged devices in communication with the server application. The server application comprises instructions to: receive a call from the paging device to send a page, determine a paging group comprising one ore more paged devices based on information associated with the call, wherein the one or more paged devices are capable of receiving the page, establish a connection to the one or more paged devices using SIP invites, and send the page to the one or more paged devices. The paging device and the paged devices may comprise telephones and/or processing devices. the system may comprise one or more computing devices configured to execute the server application.

In general, this patent application also describes a method of sending a page using SIP. The method comprises receiving a call to send the page, establishing a connection to devices using SIP invites, and sending the page to the devices via a multicast or broadcast message, where the multicast or broadcast message comprises identifiers that are recognizable to the devices to trigger playback of the page. The method may also include one or more of the following features, either alone or in combination.

The identifiers may comprise network addresses of the devices. Establishing the connection may comprise synchronizing the devices by readying the devices to receive the page. Synchronizing may be preformed by sending SIP invites to the devices and receiving responses from the devices. The method may comprise identifying a caller sending the page, and confirming that the caller is authorized to send the page. The page need not be sent if the caller is not authorized to send the page.

The method may comprise determining a paging group, where determining the paging group comprises obtaining information indicating whether a target device is in use. In a case that the target device is in use, sending the page may comprise causing audio on the target device to be augmented with the page. The page may be played on the target device at a volume that is lower than a volume of the audio. The method may also comprise obtaining page information relating to receipt or non-receipt of the page at the one ore more devices, and logging the page information.

The foregoing method of sending a page using SIP may be implemented using one or machine-readable media. The one or more machine-readable media stores instructions that are executable by one or more processing devices to perform the method. The method may be implemented using one or more apparatus and/or systems that include one or more processing devices and memory for storing instructions that are executable by one or more processing devices.

The details of one or more examples are set forth in the accompanying drawings and the description below. Further features, aspects, and advantages will become apparent from the description, the drawings, and the claims.

### DESCRIPTION OF THE DRAWINGS

FIG. 1 is a block diagram of a network on which a process form paging network devices may be implemented.

FIG. 2 is a flowchart showing a process for paging network devices.

Like reference numeral is different figures indicate like elements.

### DETAILED DESCRIPTION

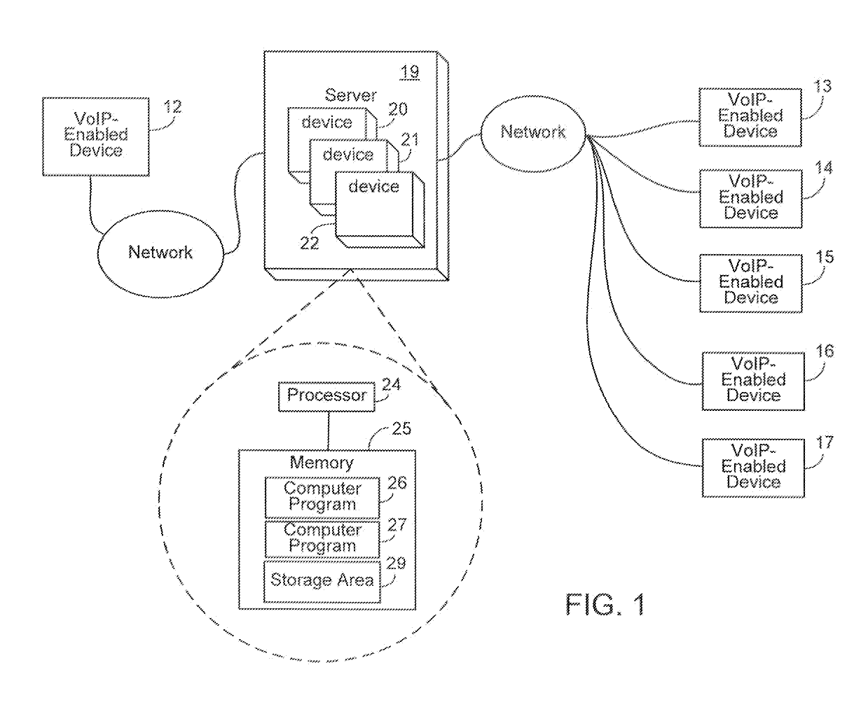

FIG. 1 shows a network 10, over which VoIP-enabled devices communicate. Network 10 may be an IP-enabled network, and may include a local area network (LAN), such as an intranet, and/or a wide area network (WAN), which may, or may not, include the Internet. Network 10 may be wired, wireless, or a combination of the two.

Network 10 includes VoIP devices 12 to 17. The VoiP devices may be VoIP-enabled telephones or any other types of devices that are capable of receiving pages and of playing audio associated with the pages. In this context, a page is a message that is transmitted as part of a special type of audio conference established among VoIP devices.

Network 10 includes a server 19. Server 19 may include one device 20 or multiple 20 to 22 (devices 21 and 22 are depicted sing dashed lines to indicate that they are optional). Each of devices 20 to 22 may have the same, or similar, hardware and/or software configuration. In this implementation, devices 20 to 22 act together to perform the various functions described below. In other implementations, a single device may perform all of the server functions. In case of multiple devices, device 20 may act as a controller or “load balancer” for the remaining devices 21 and 22. In this role, device 20 may route data, requests, and instructions between a client (e.g., a VoIP device) and a “slave” device, such as device 22. Device 20 may store information locally, then route data to another device, such as device 21. For the purposes of the following, such internal communications between device 20 and slave devices will be assumed.

Device 20 may be any type of processing device that is capable of receiving and storing data, and of communicating with VoIP clients. As shown in FIG. 1, device 20 includes one or more processors 24 and memory 25 that stores computer programs that are executed by processor(s) 25. In this regard, memory 25 stores a computer program 26 for communicating with its clients using, e.g., session initiation protocol (SIP). Memory 25 also contains on or more computer programs 27 for executing the processes described herein, and one or more storage areas 29 for storing data relating to the various VoIP devices on network 10. It is noted that FIG. 1 shows these storage area as internal to device 20; however, they may be external or a combination of internal and external.

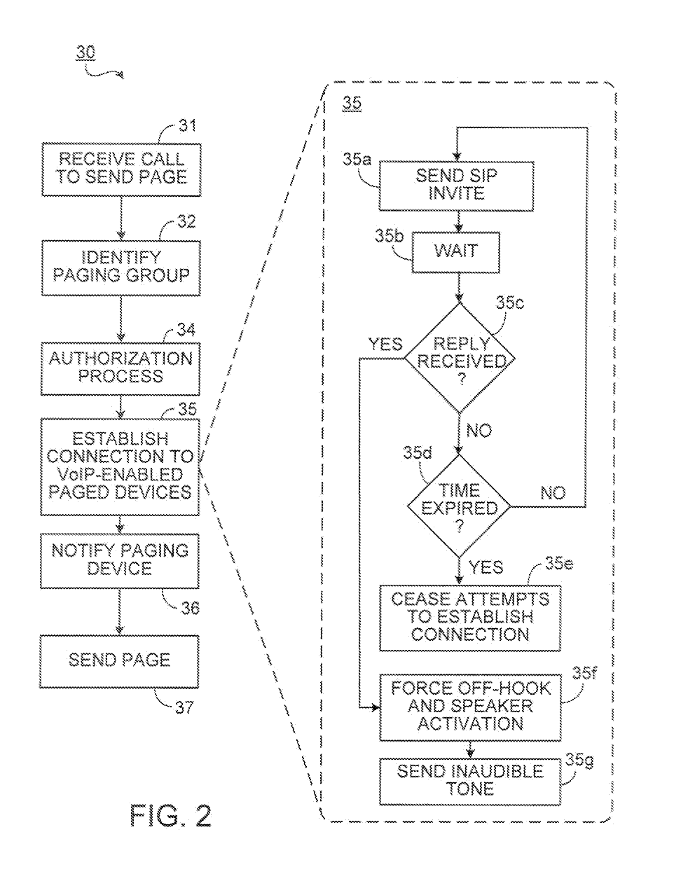

FIG. 2 shows a process 30 by which one VoIP device 12 (the paging device) sends an audible page to one or more other VoIP devices 13 to 17 (the paged devices) via server 19. Process 30 is preformed by server 19 (e.g., via computer program 27); however, it interacts with both paging device and the paged devices, as explained below.

To begin, process 30 receives (31) a call from a paging device, such as device 12, e.g., a VoIP-enabled telephone. That is, a user at device 12 dials a predefined extension, which calls server 19. The extension is indicative of a page or a paging group. For example, dialing a “70″ from device 12 may correspond to an instruction to page everyone in a particular location or facility. In this regard, server 19 contains one or more databases in storage area 29. These databases contain mappings which, among other things, correlate extensions to paging groups. This is explained in more detail below.

In this implementation, the databases in storage area 29 may contain one or more look-up tables (LUTs), which correlate device extensions to other identification information for VoIP devices, such as, but not limited to, SIP uniform resource identifiers (URIs), Internet protocol (IP) addresses, media access control (MAC) addresses, other network addresses, and various designations. In this regard, one example of a designation is “primary”. In this context, “primary” means that the corresponding extension is a primary extension of a device. That is, a single device may respond to multiple extensions, e.g., a secretary's telephone might include his/her extension and that of a boss. The designation “primary” means that the extension is the main extension for a particular device; all other extensions are secondary. Other designations may include “secondary” to indicate a non-primary extension, although failure to indicate that an extension is primary may be sufficient to designate that extension as secondary.

The foregoing information is provided to server 19 at registration of each VoIP-enabled device on network 10. In brief, upon entry into network 10, each devices required to establish its presence on the network by registering with server 19 (alone or in conjunction with one or more other servers-not shown). During the registration process, server 19 obtains and/or assigns the various information noted above. One example of a device registration process that may be used in whole or part is described in U.S. provisional application no. 60/727,130, filed on Oct. 14, 2005, the contents of which are hereby incorporated by reference into this application as if the set forth herein in full.

The call from the paging device constitutes a message that includes information, such as, but not limited to, the extension of the paging device, its SIP, URI, and its IP address. Process 30 uses at least some of this information to identify (32) the paging group that is being paged by the call. For example, process 30 may use the extension of the paging device and/or its URI to identify the paging group, e.g., the extension may be mapped to various other extensions of VoIP paged devices, which constitute the paging group. This information may be retrieved from the databases and stored temporarily for use in paging by process 30. Process 30 may also be distinguished between primary and non-primary extensions when determining which extensions should be included within a paging group. An administrator of server 19 may set-up the paging groups.

Process 30 may perform an authentication process (34) to determine whether the paging device is permitted to page the devices that are part of the paging group. For example , in school, a teacher may be authorized to page other teachers, but a student may not have such authorization. Here, the database(s) containing the mapping tables may identify which extensions(s) are permitted to page each paging group. Process 30 may check the extension of the paging device against the authorization of paging group being paged. If the paging device is permitted to page that paging group, process 30 proceeds as described below. Otherwise, process 30 may notify the paging device that it is not authorized to make the requested page. Notification may be audible, visual or a combination the two. In some implementations, process 30 may require the user to enter a personal identification number (PIN) after entering the paging extension, and then evaluate whether the user is able to make the page based on the entered PIN.

Process 30 establishes (35) connection to the paged devices. In this implementation, the connection synchronizes the various paged devices so that the page can be received and played back at substantially the same time on all paged devices. In this regard, different types and/or brands of VoIP devices may have different capabilities (e.g., processors) and, as a result, may respond to messages from the server 19 at different rates. Accordingly, process 30 synchronizes the paged devices so that they are all ready to receive, and play, a page when the page is sent form server 19. The effectively eliminates differences in page set-up time that would otherwise occur.

To establish (35) a connection to each device in the paging group, process 30 sends (35) a SIP invite to each device. Process 30 then waits (35b) for a reply to the SIP invite. If process 30 does not receive (35c) a reply within a fraction of a predetermined period of time (35d), process 30 re-sends (35a) the SIP invite. This process is repeated until the predetermined period of time expires (35d). Rather than waiting between SIP invites, process 30 may continually send SIP invites-one after another- to each device during the predetermined period of time. In this example, the predetermined period is two to three seconds; however, the invention is not limited as such and any period of time may be used. If process 30 does not receive, within the predetermined period of time, a reply to a SIP invite from a target paged device, process 30 ceases (35e) attempting to establish a connection to the target paged device. The target paged device is thus deemed to be outside the paging group for the purposes of the current page. In other implementations, further attempts at connection may be made (not shown in FIG. 2).

If process 30 receives (35c) a reply to the SIP invite from the target device within the predetermined period of time, process 30 instructs the target device to go off-hook (35f) and to activate its speaker (in case that the target device has a speaker). Thereafter, process 30 sends (35g) an inaudible tone to target device. The target device responds by playing the inaudible tone over its speaker and, if applicable, over its handset. This inaudible tone may prevent other sounds from being played. Also, the target device may be controlled to display a message, such as “Paged” on its display (if there is a display). This is done for each paged device in a selected paging group.

Connection is established in the foregoing manner to ensure that the various paged devices are in synchronism. For example, one paged device may take 0.5 seconds (s) to establish connection to the server. Another paged device may take 2.0 s to establish connection to the server. If pages were sent without fist synchronizing the devices, the result would be that the paged devices, which respond at different rates, play back the page at different times. This can result in a cacophony, particularly in close quarters. By establishing connection to paged devices in the manner set for above, the result is that each paged device that responds to the server's SIP invite is in “page mode”, i.e., the paged device is off-hook, its speaker is active, and it is playing an inaudible tone. The paged devices are thus each connected and ready to receive and play a page.

Process 30 may notify (36) the paging device when the paging group (or a subset of devices contained therein) is ready to receive a page. For example, process 30 may cause a tone to be played at the paging device. Process 30 may also force such a tone to the paged devices as well, if so configured. In response to the notification, a user at the paging device supplies the message. The user may speak words into the paging device or provide some other audible indication of meaning to users at the paged devices. The paging device may then send the page (including the words or other type of audible tone) to server 19. The paging may hang-up after sending the page. When the paging devices hangs-up, server 19 is notified and, thereafter, process 30 may cause the paged devices also to hang-up depending upon whether the page has/has not been sent.

Process 30 may send (37) the page to paging devices or process 30 may provide further interaction with the paging device prior to sending the page to the paged devices. For example, at the request of the paging device, the server may store the page and play-back the page to the paging device, thereby allowing a user at the paging device to listen to the message in the page and to edit the message as desired before sending. Alternatively, server 19 may store the page to send at a later time (which may be specified by the paging device) or prompt the paging device to indicate when to send the page. In common parlance, this situation is referred to as sending a “voice bomb”.

Process 30 sends (37) the page to paged devices using SIP. The page may be sent directly to the devices handsets and/or speakers or, alternatively, the page may be sent to a voicemail system associated with each paged device. In some cases, a paged device may be in use. In such case, a low-volume page may be used. Such a page is referred to herein as a “whisper page”. A whisper page is typically played on the paged device's headset and/or speaker at a volume that is lower than the volume of other communications being played at the same time. A user, when registering a device with server 19, may indicate whether or not whisper pages can be accepted.

Some VoIP devices have the ability to play two different audio streams at the same time. For such devices, process 30 may simply provide the contents of the whisper page in a SIP message and instruct the device to play the whisper page during other use of the device. This may be done for devices that communicate directly with one another, i.e., whose communication is not routed through server 19. For devices whose communications are routed through server 19, process 30 may simply mix the whisper page into the audio stream, specify an appropriate volume for the whisper page, and then transmit the whisper page as part of the normal course of communication.

As noted above, a user may specify whether a device is to receive a whisper page. For a device that is not to receive whisper pages, the pages may be sent directly to voicemail for that device or delayed until the device is no longer in use. Process 30 is able to determine when a paged device is no longer in use based, e.g., in response packets transmitted between the device and server 19 during a communication session. In this case, process 30 may send the page after a user is finished with the devices.

In this regard, some systems support one-way RTP media, whereas other systems support bi-directional flow of RTP packets. For systems that support bi-directional flow of RTP packets, RTP packets are sent back to server 19 in response to a page. These packets may be used by process 30, as described above, to determine when use of a paged device has ended. In other implementations, the RTP packets from the paged devices are ignored by both server 19 and the paging device.

In other implementations, when registering, a user may provide instruction(s) to route a page to a different device or extension when a targeted device or extension is in use. This may be done in addition to, or in lieu of, sending a whisper page. In this case, the page may be routed by process 30 according to such instruction(s).

Process 30 may send (37) the page by broadcasting or multicasting the page to devices 13 to 17, among others. For example, the page may be a multicast message (data packet/s) containing network identifier/s (ID/s) corresponding to one or more of devices 13 to 17. Upon receipt of a multicast page message, a recipient device parses the header of that message to determine whether the message was directed to the recipient device. If the message was directed to the recipient device, the recipient device plays the page. Otherwise, the recipient device ignores the data packet. Paging by broadcasting or multicasting may also be performed without first synchronizing the paged devices.

Process 30 may log information (e.g., in server 19) relating to which device(s) in a paging group received a page and/or how the device reacted (to the extent that such information is available to server 19). For example, process 30 may log whether a page was answered, whether the page went into voicemail, whether a whisper page was played, or any other event for which information is available. The information regarding events that occurred may be transmitted from the paged device(s) to server 19 in SIP messages. The log may be used, e.g., for liability purposes. For example, in the event of a fire, a page may be sent to all users in a facility. The log may be used, e.g., to confirm that all users received the page. Information from the log may be played back either audibly or visually on a computer, telephone, or other VoIP or non-VoIP-enabled device.

All or part of the process described herein and its various modifications (hereinafter referred to as “the process”) can be implemented, at least in part, via a computer program product, i.e., a computer program tangibly embodied in one or more information carriers, e.g., in one or more machine-readable storage media or in a propagated signal, for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing the processes can be performed by one or more programmable processors executing one or more computer programs to perform the functions of the calibration process. All or part of the processes can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer (including a server) include one or more processors for executing instructions and one or more storage area devices for storing instructions and data. Generally, a computer will also include, or be operatively coupled to receive data from, or transfer data to, or both, one or more mass storage devices for storing data, e.g., magnetic, magneto-optical disks, or optical disks. Information carriers suitable for embodying computer program instructions and data include all forms of non-volatile storage area, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks.

The processors are not limited to use with VoIP-enabled telephones or to any particular hardware or hardware manufacturer. Rather, the processes can be implemented to page any networked device, which may or may not run VoIP, Likewise, the processes are not limited to the specific hardware and protocols described herein.

Elements of different implementations described herein may be combined to form other implementations not specifically set forth above. Other implementations not specifically described herein are also within the scope of the following claims.

What is claimed is:

1. A method of sending a page using session initiation protocol (SIP), the method comprising:
receiving a call to send the page;
determining a paging group comprising one or more devices based on information associated with the call, the one or more devices being capable of receiving the page;
establishing a connection to the one or more devices using SIP invites; and
sending the page to the one or more devices.

2. The method of claim 1, wherein the information associated with the call comprises an extension contained in the call; and
wherein determining the paging group comrises retrieving information associated with one or more devices using the extension.

3. The method of claim 2, wherein the information associated with one or more services comprises at least one of an extension of a device, an indication of whether the extension is primary for the device, a SIP uniform resource identifier of a device, and and Internet Protocol address of a device.

4. The method of claim 1, wherein the one or more devices include a target device, and establishing a connection to the target device comprises:
sending a SIP invite to the target device;
waiting a predetermined period of time for a reply to the SIP invite;
wherein, if the reply is received within the predetermined amount of time, the method further comprises sending an inaudible tone to the target device; and
wherein if the reply is not received within the predetermined period of time, the method further comprises ceasing attempts to establish a connection to the target device.

5. The method of claim 4, further comprising:
repeating sending the SIP invite to the target device several times within the predetermined period of time if the target device does not reply within a fraction of the predetermined amount of time.

6. The method of claim 1, wherein establishing the connection comprises:
synchronizing the one or more devices by readying the one or more devices to receive the page;
wherein synchronizing is performed by sending SIP invites to the one or more devices and receiving responses from the one or more devices.

7. The method of claim 1, further comprising:
identifying a caller sending the page; and
confirming that the caller is authorized to send the page;
wherein the page is not sent if the caller is not authorized to send the page.

8. The method of claim 1, wherein the one or more devices include a target device, and determining the paging group comprises obtaining information indicating whether the target device is in use; and
wherein, in a case that the target device is in use, sending the page comprises causing audio on the target device to be augmented with the page, the page being played on the target device at a volume that is lower than a volume of the audio.

9. The method if claim 8, wherein causing the audio on the target device to be augmented with the page comprises one of:
instructing the target device to play the page at a same time as the audio; and
incorporating the audio into the page before sending the page.

10. The method of claim1, further comprising:
obtaining page information relating to receipt or non-receipt of the page at the one or more devices; and
logging the page information.

11. A system comprising:
a paging device;
a server application in communication with the paging device; and
paged devices in communication with the server application;
wherein the server application comprises instructions to:
receive a call from the paging device to send a page;
determine a paging group comprising one or more paged devices based on information associated with the call, the one or more paged devices being capable of receiving the page;
establish a connection to the one or more paged devices using SIP invites; and
send the page to one or more paged devices.

12. The system of claim 11, wherein the paging device and the paged devices comprise telephones; an
wherein the system further comprises one or more computing devices configured to execute the server application.

13. A method of sending a page using session initiation protocol (SIP), the method comprising:
receiving a call to send the page;
establishing a connection to devices using SIP invites; and
sending the page to the devices via a multicast or broadcast message, the multicast or broadcast message containing identifiers that are recognizable to the devices to trigger playbook of the page.

14. The method of claim 13, wherein the identifiers comprise network addresses of the devices.

15. The method of claim 13, wherein establishing the connection comprises:
synchronizing the devices by readying the devices to receive the page;
wherein synchronizing is performed by sending SIP invites to the devices and receiving responses from the devices.

16. The method if claim 13, further comprising:
identifying a caller sending the page; and
confirming that the caller is authorized to send the page;
wherein the page is not sent if the caller is not authorized to send the page.

17. The method of claim 13, further comprising:
determining a paging group, wherein determining comprises obtaining information indicating whether a target device is in use; and
wherein, in a case that the target device is in use, sending the page comprises causing audio on the target device to be augmented with the page, the page being played on the target device as a volume that is lower that a volume of the audio.

18. The method of claim 13, further comprising:
obtaining page information relating to receipt or non-receipt of the page at the one or more devices; and
logging the page information.

19. One or more machine-readable media that stores instructions that are executable to send a page using session initiation protocol (SIP), the instructions for causing on or more processing devices to:
receive a call to send the page;
determine a paging group comprising one or more devices based on information associated with the call, the one or more devices being capable of receiving the page;
establish a connection to the one or more devices using SIP invites; and
send the page to the one or more devices.

20. The one or more machine-readable media of claim 19, wherein the information associated with the call comprises an extension contained in the call; and
wherein determining the paging group comprises retrieving information associated with the one or more devices using the extension.

21. The one or more machine-readable media of claim 20, wherein the information associated with the one or more services comprises at least one of an extension of a device, an indication of whether the extension is primary for the device, a SIP uniform resource identifier of a device, and an Internet Protocol address if a device.

22. The one or more machine-readable media of claim 19, wherein the one or more devices include a target device, and establishing a connection to the target device comprises:
sending a SIP invite to the target device;
waiting a predetermined period of time for a reply to the SIP invite;
wherein, if the reply is received within the predetermined amount of time, the instructions cause the one or more processors to provide an inaudible tone to the target device; and
wherein if the reply is not received within the predetermined period of time, the instructions cause the one or more processors to cease attempts to establish a connection to the target device.

23. The one or more machine-readable media of claim 22, wherein the instructions cause the one or more processors to:
repeat sending the SIP invite to the target device several times within the predetermined period of time if the target device does not reply within a fraction of the predetermined amount of time.

24. The one or more machine-readable media of claim 19, wherein establishing the connection comprises:
synchronizing the one or more devices by readying the one or more devices to receive the page;
wherein synchronizing is performed by sending SIP invites to the one or more devices and receiving responses from the one or more devices.

25. The one or more machine-readable media of claim 19, wherein the instructions cause the one or more processors to:
identify a caller sending the page; and
confirm that the caller is authorized to send the page;
wherein the page is not sent if the caller is not authorized to send the page.

26. The one or more machine-readable media of claim 19, wherein the one or more devices include a target device, and determining the paging group comprises obtaining information indicating whether the target device is in use; and
wherein, in a case that the target device is in use, sending the page comprises causing audio on the target device to be augmented with the page, the page being played on the target device at a volume that is lower than a volume of the audio.

27. The one or more machine-readable media of claim 26, wherein causing the audio on the target device to be augmented with the page comprises one of:
instructing the target device to play the page at a same time as the audio; and
incorporating the audio into the page before sending the page.

28. The one or more machine-readable media of claim 19, wherein the instruction cause the one or more processors to:
obtain page information relating to receipt or non-receipt of the page at the one or more devices; and
log the page information.

29. One or more machine-readable media that stores instructions that are executable to send a page using session initiation protocol (SIP), the instructions for causing one or more processing devices to:
receive a call to send the page;
establish a connection to devices using SIP invites; and
send the page to the devices via a multicast or broadcast message, the multicast or broadcast message containing identifiers that are recognizable to the devices to trigger playback of the page.

30. The one or more machine-readable media of claim 29, wherein the identifiers comprise network addresses of the devices.

31. The one or more machine-readable media of claim 29, wherein establishing the connection comprises:
synchronizing the devices by readying the devices to receive the page;
wherein synchronizing is performed by sending SIP invites to the devices and receiving responses from the devices.

32. The one or more machine-readable media of claim 29, wherein the instructions cause the one or more processing devices to:
identify a caller sending the page; and
confirm that the caller is authorized to send the page;
wherein the page is not sent of the caller is not authorized to send the page.

33. The one or more machine-readable media of claim 29, wherein the instructions cause the one or more processing devices to:
determine a paging group, wherein determining comprises obtaining information indicating whether a target device is in use; and
wherein, in a case that the target device is in use, sending the page comprises causing audio on the target device to be augmented with the page, the page being played on the target device at a volume that is lower than a volume of the audio.

34. The one or more machine-readable media of claim 29, wherein the instructions cause the one or more processing devices to:
obtain page information relating to receipt or non-receipt of the page at the one or more devices; and
log the page information.
